(19) United States
(12) Patent Application Publication
(10) Pub. No.: US 2012/0083188 A1
(43) Pub. Date: Apr. 5, 2012

(54) DISPERSION COMPRISING CERIUM OXIDE AND SILICON DIOXIDE

(75) Inventors: Michael Kroell, Linsengericht (DE); Wolfgang Lortz, Waechtersbach (DE); Stefan Heberer, Offenbach (DE); Mario Brands, Frankenthal (DE); Yuzhuo Li, Heidelberg (DE); Bettina Drescher, Ludwigshafen (DE); Diana Franz, Schifferstadt (DE)

(73) Assignees: BASF SE, Ludwigshafen (DE); EVONIK DEGUSSA GMBH, Essen (DE)

(21) Appl. No.: 13/377,005

(22) PCT Filed: May 18, 2010
(86) PCT No.: PCT/EP10/56781

§ 371 Date: Dec. 8, 2011

(30) Foreign Application Priority Data
Jun. 25, 2009 (DE) 10 2009 027 211.9
Nov. 18, 2009 (DE) 10 2009 046 849.8

(51) Int. Cl. B24B 1/00; C09K 13/04; C09K 13/00; C09K 3/14; B24D 3/00

(52) U.S. Cl. 451/28; 51/308; 252/79.1; 252/79.2

(57) ABSTRACT

Aqueous dispersion comprising cerium oxide and silicon dioxide, obtainable by first mixing a cerium oxide starting dispersion and a silicon dioxide starting dispersion while stirring, and then dispersing at a shear rate of 10000 to 30000 s⁻¹, wherein a) the cerium oxide starting dispersion—contains 0.5 to 30% by weight of cerium oxide particles as the solid phase, —a d5o of the particle size distribution of 10 to 100 nm—and has a pH of 1 to 7, and b) the silicon dioxide starting dispersion—contains 0.1 to 30% by weight of colloidal silicon dioxide particles as the solid phase, has a d5o of the particle size distribution of 3 to 50 nm and has a pH of 6 to 11.5, d) with the proviso that the d5o of the particle size distribution of the cerium oxide particles is greater than that of the silicon dioxide particles, the cerium oxide/silicon dioxide weight ratio is >1 and the amount of cerium oxide starting dispersion is such that the zeta potential of the dispersion is negative.

The invention relates to the preparation of a dispersion comprising cerium oxide and colloidal silicon dioxide, and to the dispersion itself.

It is known that cerium oxide dispersions can be used to polish glass surfaces, metal surfaces and dielectric surfaces, both for coarse polishing (high material removal, irregular profile, scratches) and for fine polishing (low material removal, smooth surfaces, few scratches, if any). A disadvantage is often found to be that cerium oxide particles and the surface to be polished bear different electrical charges and attract one another as a result. As a consequence, it is difficult to remove the cerium oxide particles from the polished surface again.

U.S. Pat. No. 7,112,123 discloses a dispersion for polishing glass surfaces, metal surfaces and dielectric surfaces, which comprises, as an abrasive, from 0.1 to 50% by weight of cerium oxide particles and from 0.1 to 10% by weight of clay abrasive particles, 90% of the clay abrasive particles having a particle diameter of from 10 nm to 10 μm and 90% of the cerium oxide particles having a particle diameter of from 100 nm to 10 μm. Cerium oxide particles, clay abrasive particles and glass as the surface to be polished have a negative surface charge. Such a dispersion enables significantly higher material removal than a dispersion based only on cerium oxide particles. However, such a dispersion causes a high defect rate.

U.S. Pat. No. 5,891,205 discloses an alkaline dispersion which comprises silicon dioxide and cerium oxide. The particle size of the cerium oxide particles is less than or equal to the size of the silicon dioxide particles. The cerium oxide particles present in the dispersion stem from a gas phase process, are not aggregated and have a particle size which is less than or equal to 100 nm. According to U.S. Pat. No. 5,891,205, the presence of cerium oxide particles and silicon dioxide particles allows the removal rate to be increased drastically. In order to achieve this, the silicon dioxide/cerium oxide weight ratio should be from 7.5:1 to 1:1. The silicon dioxide preferably has a particle size of less than 50 nm and the cerium oxide one of less than 40 nm. In summary, the proportion a) of silicon dioxide is greater than the proportion of cerium oxide and b) the silicon dioxide particles are larger than the cerium oxide particles. The dispersion disclosed in U.S. Pat. No. 5,891,205 enables significantly higher removal than a dispersion based only on cerium oxide particles. However, such a dispersion causes a high defect rate.

U.S. Pat. No. 6,491,843 discloses an aqueous dispersion which is said to have a high selectivity with regard to the removal rate of SiO₂ and Si₃N₄. This dispersion comprises abrasive particles and an organic compound which has both a carboxyl group and a second chloride- or amine-containing functional group. Suitable organic compounds mentioned are amino acids. In principle, all abrasive particles are said to be suitable, preference being given especially to aluminium oxide, cerium oxide, copper oxide, iron oxide, nickel oxide, manganese oxide, silicon dioxide, silicon carbide, silicon nitride, tin oxide, titanium dioxide, titanium carbide, tungsten oxide, yttrium oxide, zirconium oxide or mixtures of the aforementioned compounds. In the working examples, however, only cerium oxide is specified as abrasive particles.

German patent application 102007062572.5 filed Dec. 22, 2007 claims a dispersion which comprises particles of cerium oxide and colloidal silicon dioxide, wherein the zeta potential of the silicon dioxide particles is negative and that of the cerium oxide particles is positive or equal to zero, and the zeta potential of the dispersion overall is negative. Moreover, the mean diameter of the cerium oxide particles is not more than 200 nm and that of the silicon dioxide particles is less than 100 nm, and the proportion of cerium oxide particles is 0.1 to 5% by weight and that of silicon dioxide particles is 0.01 to 10% by weight. The pH of the dispersion is 3.5 to <7.5. The dispersion can be prepared by combining preliminary dispersions which comprise cerium oxide particles and silicon dioxide particles and then dispersing them. In this context, the dispersion conditions are of no significance. The dispersions claimed allow surfaces to be polished with a low defect rate and high selectivity and only minor or no deposits remain on the polished surface.

It has now been found that, surprisingly, principally by virtue of particular feedstocks and dispersing conditions, it is possible to obtain a dispersion with which polishing results improved once again can be achieved. More particularly, the particle formation caused by electrostatic interaction between cerium oxide particles and particles, as present after the detachment of surface particles, are minimized. In addition, the dispersion should maintain its stability in the course of the polishing operation, and the formation of large particles which can form defects in the course of polishing should be avoided.

The invention therefore firstly provides an aqueous dispersion comprising cerium oxide and silicon dioxide, obtainable by first mixing a cerium oxide starting dispersion and a silicon dioxide starting dispersion while stirring, and then dispersing at a shear rate of 10000 to 30000 s⁻¹, wherein

a) the cerium oxide starting dispersion
contains 0.5 to 30% by weight of cerium oxide particles as the solid phase,
has a d₅₀ of the particle size distribution of 10 to 100 nm
and has a pH of 1 to 7, preferably of 3 to 5, and

b) the silicon dioxide starting dispersion
contains 0.1 to 30% by weight of colloidal silicon dioxide particles as the solid phase,
has a d₅₀ of the particle size distribution of 3 to 50 nm and
has a pH of 6 to 11.5, preferably 8 to 10,

c) with the proviso that
the d₅₀ of the particle size distribution of the cerium oxide particles is greater than that of the silicon dioxide particles,
the cerium oxide/silicon dioxide weight ratio is >1 and
the amount of cerium oxide starting dispersion is such that the zeta potential of the dispersion is negative, preferably −0.1 to −30 mV.

The dispersion can optionally be diluted with water.

The shear rate is expressed in the present invention as the quotient of peripheral speed, divided by the distance between the surfaces of rotor and stator. The peripheral speeds can be calculated from the speed of the rotor and the rotor diameter. In a preferred embodiment of the invention, the shear rate is 12000 to 25000 s⁻¹; in a particularly preferred embodiment it is 15000 to 20000 s⁻¹. Shear rates of less than 10000 s⁻¹ or more than 30000 s⁻¹ lead to less good polishing results. Even though there is not yet a possible mechanism for influencing the shear rate, it is important to have available a particular arrangement of the positively charged, larger cerium oxide particles and of the smaller, negatively charged silicon dioxide particles in the polishing process. It is assumed that, as a result of electrostatic attraction, the silicon dioxide particles become arranged around individual cerium oxide particles or around an aggregate of cerium oxide particles. A suitable dispersing unit may, for example, be a rotor-stator machine.

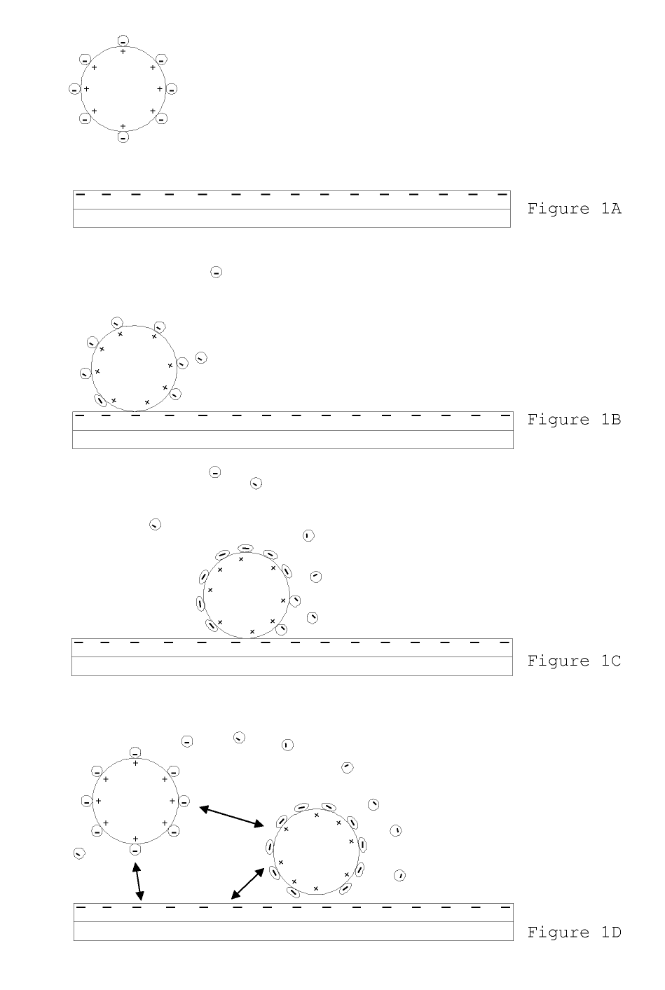

FIGS. 1A to 1D show one possible mechanism in the operation of polishing a negatively charged SiO₂ surface, which itself constitutes the surface of a silicon layer, using the inventive dispersion. In FIGS. 1A to 1D, a cerium oxide particle is represented by a large circle which bears positive charges. The silicon dioxide particles are represented by smaller circles which bear a negative charge. The particles detached from the surface to be polished are represented by ellipses which bear a negative charge.

FIG. 1A describes the situation before commencement of the polishing operation. It shows the arrangement of a cerium oxide particle with the silicon dioxide particles surrounding it, formed by electrostatic attraction.

FIG. 1B shows that, under polishing conditions, a silicon dioxide particle is removed from the cerium oxide particle and replaced by a silicon dioxide particle from the surface to be polished.

FIG. 1C shows the continuation of the polishing operation. Here, the colloidal silicon dioxide particles which originally surrounded the cerium oxide particles are present in the dispersion, while the detached silicon dioxide particles are bound electrostatically to the cerium oxide particles.

FIG. 1D shows the interaction of a newly arriving cerium oxide particle having the negatively charged, colloidal silicon dioxide particles surrounding it with a cerium oxide particle which bears silicon dioxide particles from the polished surface. The arrows show the electrostatic repulsion between the particles before and after polishing, and the electrostatic repulsion between the surface to be polished and the particles before and after the polishing.

The cerium oxide content in the starting dispersion is preferably 0.5 to 15% by weight and more preferably 1 to 10% by weight, based on the starting dispersion.

The colloidal silicon dioxide content in the starting dispersion is preferably 0.25 to 15% by weight, more preferably 0.5 to 5% by weight, based on the starting dispersion.

The cerium oxide/silicon dioxide weight ratio in the inventive dispersion is preferably 1.1:1 to 100:1. Particular preference may be given to a cerium oxide/silicon dioxide weight ratio of 1.25:1 to 5:1.

In addition, preference may be given to an inventive dispersion in which no further particles are present apart from cerium oxide particles and colloidal silicon dioxide particles.

The d₅₀ of the particle size distribution of the cerium oxide particles used is not more than 10 to 100 nm. Preference may be given to a range of 40 to 90 nm. The cerium oxide particles may be used in the form of isolated individual particles, or else in the form of aggregated primary particles. Preference may be given to using aggregated or predominantly aggregated cerium oxide particles.

Particularly suitable cerium oxide particles have been found to be those which contain carbonate groups on their surface and in layers close to the surface, especially those as disclosed in DE-A-102005038136. These are cerium oxide particles which
have a BET surface area of from 25 to 150 m²/g,
the primary particles have a mean diameter of from 5 to 50 nm,
the layer of the primary particles close to the surface has a depth of approx. 5 nm,
in the layer close to the surface, the carbonate concentration, proceeding from the surface at which the carbonate concentration is at its highest, decreases toward the interior,
the carbon content on the surface which stems from the carbonate groups is from 5 to 50 area per cent and, in the layer close to the surface, is from 0 to 30 area per cent in a depth of approx. 5 nm
the content of cerium oxide, calculated as CeO₂ and based on the powder, is at least 99.5% by weight and
the content of carbon, comprising organic and inorganic carbon, is from 0.01 to 0.3% by weight, based on the powder.

The carbonate groups can be detected both at the surface and in a depth up to approx. 5 nm of the cerium oxide particles. The carbonate groups are chemically bonded and may, for example, be arranged as in the structures a-c.

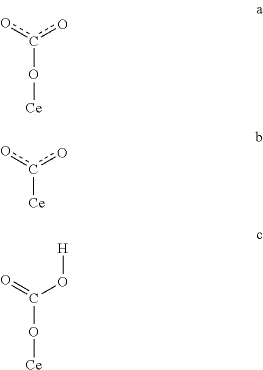

The carbonate groups can be detected, for example, by XPS/ESCA analysis. To detect the carbonate groups in the layer close to the surface, some of the surface can be ablated by means of argon ion bombardment, and the new surface which arises can likewise be analyzed by means of XPS/ESCA (XPS=X-ray Photoelectron Spectroscopy; ESCA=Electron Spectroscopy for Chemical Analysis).

The sodium content is generally not more than 5 ppm and the chlorine content not more than 20 ppm. The elements mentioned are generally tolerable only in small amounts in chemical-mechanical polishing.

The cerium oxide particles used preferably have a BET surface area of 30 to 100 m²/g and more preferably of 40 to 80 m²/g.

The colloidal silicon dioxide particles used have a d₅₀ of the particle size distribution of 3 to 50 nm. The range may be from 5 to 30 nm, more preferably 5 to 15 nm. The BET surface area of the colloidal silicon dioxide particles is preferably 50 to 900 m²/g and more preferably 200 to 450 m²/g. Colloidal silicon dioxide particles are understood to mean those which are present in the form of individual particles which are uncrosslinked to one another and have hydroxyl groups on the surface. The silicon dioxide is preferably an amorphous silicon dioxide.

The liquid phase of the inventive dispersion comprises water, organic solvents and mixtures of water with organic solvents. In general, the main constituent with a proportion of >90% by weight of the liquid phase is water.

The starting dispersions for preparing the inventive dispersion may comprise acids or bases. Acids or bases can also be added to the inventive dispersion in order to adjust the pH.

More particularly, it may be advantageous to adjust the pH of the dispersion to values of 5.5 to 6.5 by adding one or more acids. The pH is adjusted after the dispersing step while stirring.

More particularly, it may be advantageous that the dispersing is followed by adjustment of the pH of the dispersion to 5.5 to 7 or 3 to 5.

The acids used may be inorganic acids, organic acids or mixtures of the above. The inorganic acids used may especially be phosphoric acid, phosphorus acid, nitric acid, sulphuric acid, mixtures thereof, and the acidic salts thereof. Useful organic acids preferably include carboxylic acids of the general formula CₙH₂ₙ₊₁CO₂H where n=0-6 or n=8, 10, 12, 14, 16, or dicarboxylic acids of the general formula HO₂C(CH₂)ₙCO₂H, where n=0-4, or hydroxycarboxylic acids of the general formula R₁R₂C(OH)CO₂H, where R₁═H, R₂═CH₃, CH₂CO₂H, CH(OH)CO₂H, or phthalic acid or salicylic acid, or acidic salts of the aforementioned acids or mixtures of the aforementioned acids and salts thereof. Preference is given to using nitric acid, hydrochloric acid, acetic acid or formic acid.

The pH can be increased by adding ammonia, alkali metal hydroxides or amines.

The inventive dispersion may further comprise one or more aminocarboxylic acids with a content, in total, of 0.01 to 5% by weight, based on the dispersion. These are preferably selected from the group consisting of alanine, 4-aminobutanecarboxylic acid, 6-aminohexanecarboxylic acid, 12-aminolauric acid, arginine, aspartic acid, glutamic acid, glycine, glycylglycine, lysine and proline. Particular preference may be given to glutamic acid or proline. The content of amino acid or salt thereof in the dispersion may preferably be 0.1 to 0.6% by weight.

In particular applications, it may be advantageous when the inventive dispersion contains 0.3-20% by weight of an oxidizing agent. For this purpose, it is possible to use hydrogen peroxide, a hydrogen peroxide adduct, for example the urea adduct, an organic peracid, an inorganic peracid, an imino peracid, a persulphate, perborate, percarbonate, oxidizing metal salts and/or mixtures of the above. Owing to the reduced stability of some oxidizing agents toward other constituents of the inventive dispersion, it may be advisable not to add them until immediately before the utilization of the dispersion. The inventive dispersion may further comprise oxidation activators. Suitable oxidation activators may be the metal salts of Ag, Co, Cr, Cu, Fe, Mo, Mn, Ni, Os, Pd, Ru, Sn, Ti, V and mixtures thereof.

Also suitable are carboxylic acids, nitriles, ureas, amides and esters. Iron(II) nitrate may be particularly preferred. The concentration of the oxidation catalyst may, depending on the oxidizing agent and the polishing task, be varied within a range between 0.001 and 2% by weight. More preferably, the range may be between 0.01 and 0.05% by weight. The corrosion inhibitors, which are generally present in the inventive dispersion with a content of 0.001 to 2% by weight, may be nitrogen-containing heterocycles such as benzotriazole, substituted benzimidazoles, substituted pyrazines, substituted pyrazoles and mixtures thereof.

The invention further provides a process for preparing the dispersion by first mixing a cerium oxide starting dispersion and a silicon dioxide starting dispersion while stirring and then dispersing at a shear rate of 10000 to 30000 s⁻¹, wherein

a) the cerium oxide starting dispersion
contains 0.5 to 30% by weight of cerium oxide particles as the solid phase,
has a d₅₀ of the particle size distribution of 10 to 100 nm
and has a pH of 1 to 7, and

b) the silicon dioxide starting dispersion
contains 0.1 to 30% by weight of colloidal silicon dioxide particles as the solid phase,
has a d₅₀ of the particle size distribution of 3 to 50 nm and
has a pH of 6 to 11.5,

c) with the proviso that
the d₅₀ of the particle size distribution of the cerium oxide particles is greater than that of the silicon dioxide particles,
the cerium oxide/silicon dioxide weight ratio is >1 and
the amount of cerium oxide starting dispersion is such that the zeta potential of the dispersion is negative.

The invention further provides a dispersion, comprising cerium oxide particles coated or partly coated by colloidal silicon dioxide particles, wherein silicon dioxide particles and cerium oxide particles are bonded to one another by an electrostatic interaction and where
the d₅₀ of the particle size distribution of the cerium oxide particles is 10 to 100 nm and that of the silicon dioxide particles is 3 to 50 nm,
with the proviso that
   the d₅₀ of the particle size distribution of the cerium oxide particles is greater than that of the silicon dioxide particles,
   the cerium oxide/silicon dioxide weight ratio is >1 and
   the zeta potential of the dispersion is negative.

It has been found that an especially suitable dispersion for polishing silicon dioxide layers is one in which
a) the content of cerium oxide particles is 0.5 to 10% by weight, preferably 1 to 5% by weight
b) the weight ratio of cerium oxide to silicon dioxide is 1.25 to 5, preferably 1.5 to 3, more preferably 1.8 to 2.5, and
c) the pH is 5.5 to 7, preferably 6 to 7.

The invention therefore also provides a process in which a silicon dioxide layer on a substrate of silicon, preferably polycrystalline silicon, is polished using a polishing dispersion comprising this dispersion. The use of the polishing dispersion achieves a ratio of the silicon dioxide/silicon removal rate of at least 50, preferably at least 1000.

It has additionally been found that an especially suitable dispersion for polishing silicon dioxide layers with different topographies is one in which
a) the content of cerium oxide particles is 0.5 to 10% by weight, preferably 1 to 5% by weight
b) the weight ratio of cerium oxide to silicon dioxide is 1.25 to 5, preferably 1.5 to 3, more preferably 1.8 to 2.5, and
c) the pH is 3 to 5, preferably 3.5 to 4.5.

The invention therefore also provides a process in which silicon dioxide layers with different topographies are polished using a polishing dispersion comprising this dispersion. This means that the dispersion in the course of polishing preferentially removes elevations and structures (“step height removal rate”). Thus, the ratio of the elevation/substrate removal rates in the case of use of the inventive dispersion is at least 1.5:1, preferably 1.5:1 to 5:1.

### EXAMPLES

Analysis

The zeta potential is determined in the pH range of 3-12 by means of the electrokinetic sound amplitude (ESA). To this end, a suspension comprising 1% cerium oxide is prepared. The dispersing is effected with an ultrasound probe (400 W). The suspension is stirred with a magnetic stirrer and pumped by means of a peristaltic pump through the PPL-80 sensor of the Matec ESA-8000 instrument. From the starting pH, the potentiometric titration with 5M NaOH commences up to pH 12. The back-titration to pH 4 is undertaken with 5M HNO₃. The evaluation is effected by means of the instrument software version pcava 5.94.

$$ζ = \frac{ESA \cdot η}{φ \cdot Δ ρ \cdot c \cdot \vert G ( α ) \vert \cdot ɛ \cdot {ɛ}_{r}}$$

where ζ=zeta potential, φ=volume fraction, Δρ=density difference between particles and liquid, c=speed of sound in the suspension, η=viscosity of the liquid, ε=dielectric constant of the suspension, |G(α)|=correction for inertia.

The particle sizes can be determined by suitable methods known to those skilled in the art. For example, the determination can be effected by means of dynamic light scattering or by statistical evaluation of TEM images.

Feedstocks

Preparation of a cerium oxide starting dispersion: The reservoir vessel of a Conti TDS 3 rotor-stator machine is initially charged with 35 kg of demineralized water and 1 kg of nitric acid (pH 1.5), and (approx. 10 kg) of cerium oxide, prepared according to example 2, DE-A-102005038136, is sucked in portions. The pH is adjusted to values between 3.5 and 2.5 by adding nitric acid after addition of individual portions. Dispersing is effected at a shear rate of 20 000 s⁻¹ for 30 minutes, in the course of which a further 2 kg of demineralized water are added. At the end of the dispersing, a pH of 2.6 is established.

This dispersion is subsequently ground twice at 250 MPa by means of high-pressure grinding (Sugino). The pH directly after the grinding is 2.85.

The d₅₀ of the particle size distribution determined by means of Horiba LB-500 is 75 nm, the d₉₀ is 122 nm and the d₉₉ is 171 nm. The cerium oxide content is 42% by weight. The cerium oxide starting dispersion is obtained by diluting with demineralized water to a cerium oxide content of 4% by weight. The zeta potential of the starting dispersion is 55 mV.

The colloidal silicon dioxide starting dispersion used is NexSil® 5 from Nyacol, with a silicon dioxide content of 15% by weight, which is diluted to a content of 4% by weight of silicon dioxide by diluting with water. The d₅₀ of the particle size distribution is 6 nm, the BET surface area 450 m²/g. The zeta potential of the silicon dioxide starting dispersion is −28 mV.

Preparation of Inventive Dispersions

Dispersion 1: The reservoir vessel of an Ystral Conti TDS 3 is initially charged with 26 kg of the cerium oxide starting dispersion diluted to 4% by weight of cerium oxide with demineralized water, and 12.5 kg of demineralized water. At a shear rate of 8000 s⁻¹, 13 kg of NexSil 5 dispersion, which have been diluted beforehand with demineralized water from silicon dioxide content 15% by weight to 4% by weight, are added rapidly as the silicon dioxide starting dispersion. A pH of 9.7 is established. The mixture is subsequently dispersed at a shear rate of 15700 s⁻¹ over a period of 20 minutes. Subsequently, under the same dispersing conditions, 420 g of three per cent nitric acid are added, which establishes a pH of approximately 6.3. Subsequently, the mixture is made up to a total weight of 52 kg with demineralized water.

The dispersion 1 has a cerium oxide content of 2% by weight and a colloidal silicon dioxide content of 1% by weight. The d₅₀ of the particle size distribution determined by means of Horiba LB-500 is 155 nm, the d₉₀ is 240 nm and the d₉₉ is 322 nm. The zeta potential of the dispersion 1 is −8 mV.

Dispersion 2: As dispersion 1, except that 580 g are now added instead of 420 g of three per cent nitric acid, which establishes a pH of 4.1. The particle size distribution is the same as for dispersion 1.

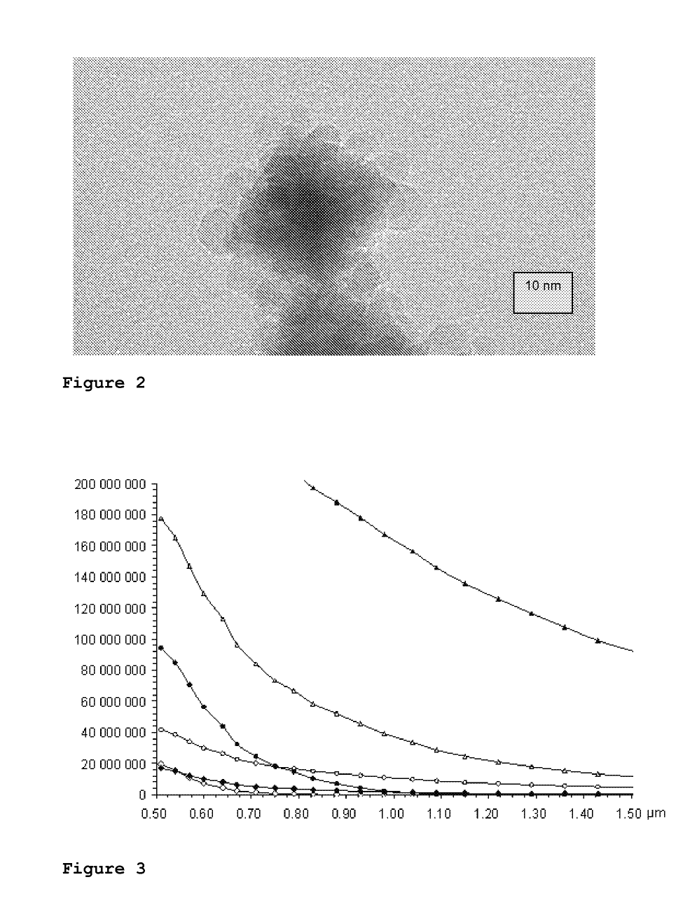

FIG. 2 shows a high-resolution TEM image of the core of a cerium oxide particle with surrounding silicon dioxide particles, which is present in the inventive dispersion.

Polishing Test Conditions

The above inventive dispersion 1 is converted to a “ready-to-use” slurry at a constant pH of 6.3 by diluting by the factor of 2. In an illustrative polishing test, an 8″ PETEOS wafer is polished on a Strasbaugh 6EC polisher with a slurry flow rate of 200 ml/min. The pad used is a Rohm&Haas IC1000-XY-K-grooved. At a pressure of 3.5 psi and pad and chuck rotation speeds of 95 l/s and 85 l/s respectively, a removal rate of 350 nm/min is found. The conditioning is effected at 9 lbs in situ.

FIG. 3 shows the large particle count (LPC, number per ml of dispersion) in the dispersion before and after the polishing as a function of the size thereof in μm.

The inventive dispersion is represented by ⋄. In addition, the results of two further polishing tests are shown, in which only cerium oxide particles are used. Unfilled symbols mean the LPC before the polishing operation, solid symbols after the polishing operation.

In addition, the inventive dispersion 1 was used to carry out polishing tests to determine the removal rates of silicon dioxide versus polycrystalline silicon. The comparison used was a comparative dispersion which comprised only cerium oxide particles of the same concentration instead of the cerium oxide/silicon dioxide particles according to the present invention.

TABLE 1
Removal rates [angström/Minute]

| | Removal rate | | |
|---|---|---|---|
| | SiO₂ | Silicon | SiO₂/Si |
| Dispersion 1 | 2967 | 25 | 119 |
| Comparative | 6490 | 493 | 13 |
| dispersion | | | |

The values from Table 1 demonstrate the high SiO₂/Si selectivity of the inventive dispersion.

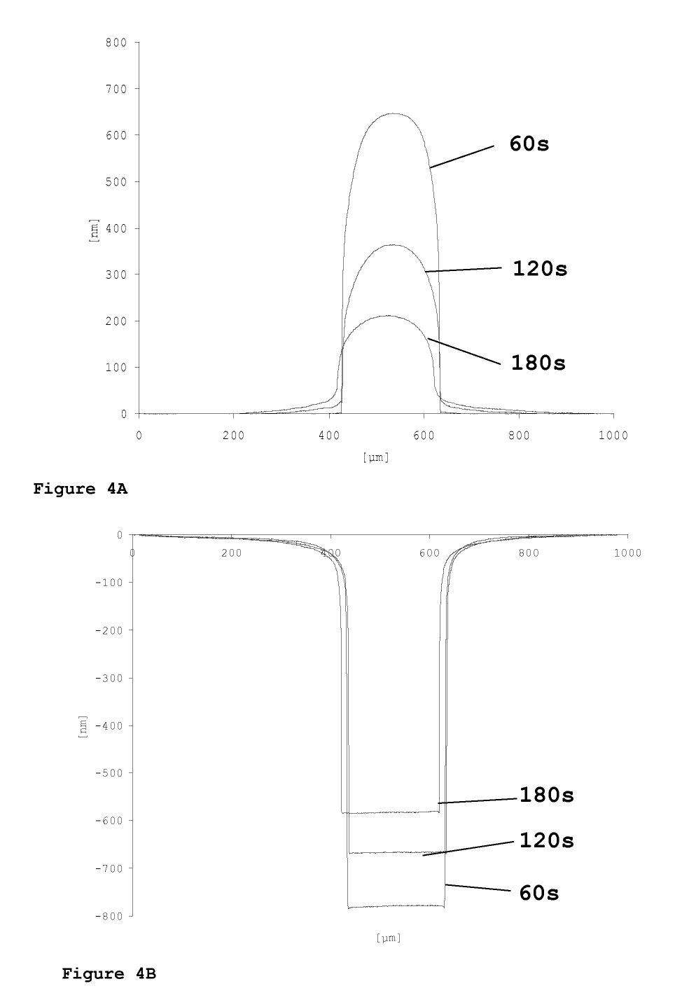

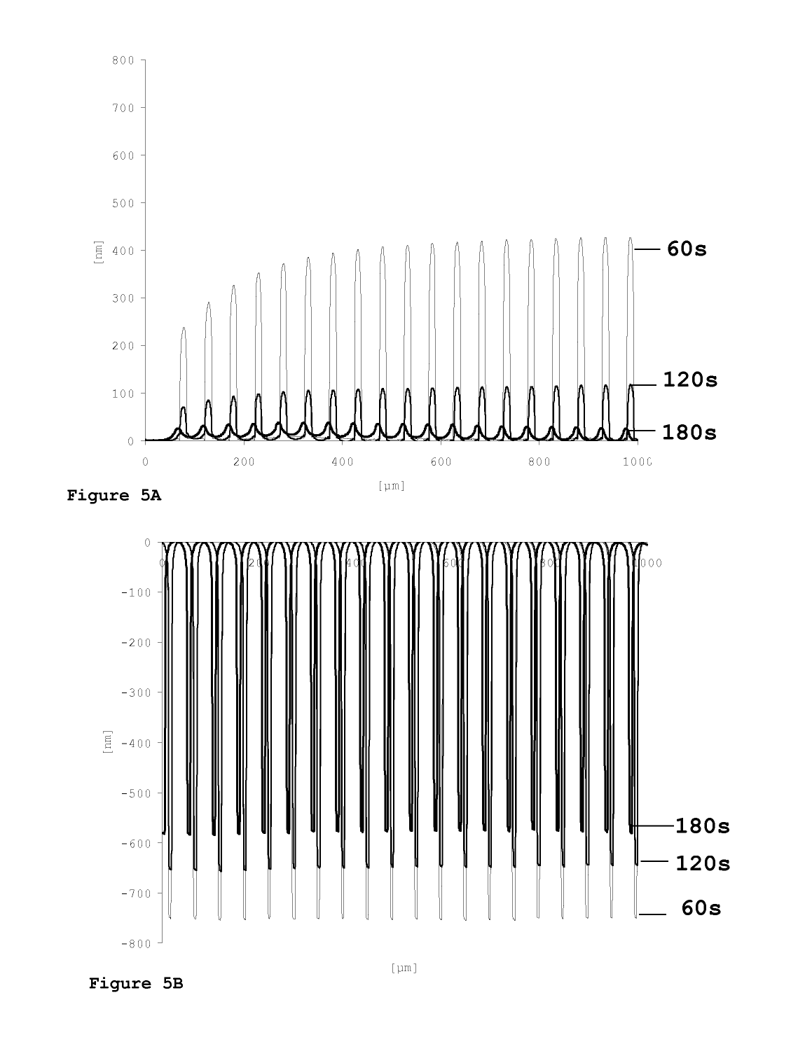

FIGS. 4A, 4B, 5A and 5B show the results in the case of use of the inventive dispersion 2 in the polishing of elevations of SiO₂ on an SiO₂ substrate (“step height reduction”). The scan width in μm is plotted on the x-axis of FIGS. 4A and 5A, and the height of the elevations in μm in the case of a polishing time of 60 s, 120 s and 180 s on the y-axis. The x-axis of FIGS. 4B and 5B likewise shows the scan width in μm, whereas the y-axis shows the profile height of the planar substrate in μm in the case of a polishing time of 60 s, 120 s and 180 s. This shows the high efficiency which is possible with the inventive dispersion in “step height reduction”. The polishing conditions were:

Down Force (DF): 4.2 psi

Slurry Flow (SF): 100 ml/min

Platen Speed (PS): 50 rpm

Carrier Speed (CS): 91 rpm

Pad: IC 1000 perf. k-grv.

1. An aqueous dispersion, comprising:
cerium oxide and
silicon dioxide,
wherein the dispersion is obtained by a process comprising first mixing a cerium oxide starting dispersion and a silicon dioxide starting dispersion while stirring, and then dispersing at a shear rate of from 10000 to 30000 s⁻¹,
the cerium oxide starting dispersion comprises from 0.5 to 30% by weight of cerium oxide particles as the solid phase,
a d₅₀ of a particle size distribution of the cerium oxide particles is from 10 to 100 nm,
a pH of the cerium oxide starting dispersion is from 1 to 7,
the silicon dioxide starting dispersion comprises from 0.1 to 30% by weight of colloidal silicon dioxide particles as a solid phase,
a d₅₀ of a particle size distribution of the silicon dioxide particles is from 3 to 50 nm,
a pH of the silicon dioxide starting dispersion is from 6 to 11.5,
the d₅₀ of the particle size distribution of the cerium oxide particles is greater than the d₅₀ of the particle size distribution of the silicon dioxide particles,
a weight ratio of cerium oxide to silicon dioxide is >1, and
a zeta potential of the cerium oxide starting dispersion is negative.

2. The dispersion of claim 1, wherein the shear rate is 12000 to 20000 s⁻¹.

3. The dispersion of claim 1,
wherein a content of the cerium oxide in the cerium oxide starting dispersion is from 0.5 to 15% by weight,

4. The dispersion of claim 1,
wherein a content of the colloidal silicon dioxide in the silicon oxide starting dispersion is from 0.25 to 15% by weight.

5. The dispersion of claim 1,
wherein the weight ratio of cerium oxide to silicon dioxide is from 1.1:1 to 100:1.

6. The dispersion of claim 1,
wherein the dispersing is followed by adding nitric acid, hydrochloric acid, acetic acid, or formic acid, thereby establishing a pH of the dispersion of from 5.5 to 6.5.

7. The dispersion of claim 1,
wherein the dispersing is followed by establishing a pH of the dispersion of from 5.5 to 7.

8. The dispersion of claim 1,
wherein the dispersing is followed by establishing a pH of the dispersion of from 3 to 5.

9. A process for preparing the dispersion of claim 1, comprising:
first mixing a cerium oxide starting dispersion and a silicon dioxide starting dispersion while stirring, and then
dispersing at a shear rate of from 10000 to 30000 s⁻¹,
wherein the cerium oxide starting dispersion comprises from 0.5 to 30% by weight of cerium oxide particles as a solid phase,
a d₅₀ of a particle size distribution of the cerium oxide particles is from 10 to 100 nm,
a pH of the cerium oxide starting dispersion is from 1 to 7,
the silicon dioxide starting dispersion comprises from 0.1 to 30% by weight of colloidal silicon dioxide particles as a solid phase,
a d₅₀ of a particle size distribution of the silicon dioxide particles is from 3 to 50 nm,
a pH of the silicon dioxide starting dispersion is from 6 to 11.5,
the d₅₀ of the particle size distribution of the cerium oxide particles is greater than the d₅₀ of the particle size distribution of the silicon dioxide particles,
a weight ratio of cerium oxide to silicon dioxide is >1, and
a zeta potential of the cerium oxide starting dispersion is negative.

10. A dispersion comprising cerium oxide particles coated or partly coated by colloidal silicon dioxide particles,
wherein silicon dioxide particles and cerium oxide particles are bonded to one another by an electrostatic interaction,
a d₅₀ of a particle size distribution of the cerium oxide particles is from 10 to 100 nm,
a d₅₀ of a particle size distribution of the silicon dioxide particles is from 3 to 50 nm,
the d₅₀ of the particle size distribution of the cerium oxide particles is greater than the d₅₀ of the particle size distribution of the silicon dioxide particles,
a weight ratio of cerium oxide to silicon dioxide is >1, and
a zeta potential of the dispersion is negative.

11. The dispersion of claim 10,
wherein a content of cerium oxide particles is from 0.5 to 10% by weight,
the weight ratio of cerium oxide to silicon dioxide is from 1.25 to 5, and
a pH of the dispersion is from 5.5 to 7.

12. A process for polishing a silicon dioxide layer on a substrate of silicon, the process comprising:
polishing the silicon dioxide layer with a polishing dispersion comprising the dispersion of claim 11.

13. The dispersion of claim 10,
wherein a content of cerium oxide particles is from 0.5 to 10% by weight,
the weight ratio of cerium oxide to silicon dioxide is 1.25 to 5, and
a pH of the dispersion is from 3 to 5.

14. A process for polishing silicon dioxide layers with different topographies or a silicon dioxide layer with varying topography, the process comprising:
polishing the silicon dioxide layers or the silicon dioxide layer with a polishing dispersion comprising the dispersion of claim 13.

15. The dispersion of claim 1, wherein the zeta potential of the cerium oxide starting dispersion is from −0.1 to −30 mV.

16. The dispersion of claim 1, comprising no further particles apart from cerium oxide particles and silicon dioxide particles.

17. The dispersion of claim 1, wherein a surface of the cerium oxide particles or a layer close to the surface of the cerium oxide particles comprises a carbonate group.

18. The dispersion of claim 1, wherein the silicon dioxide particles comprise amorphous silicon dioxide.

19. The dispersion of claim 1, further comprising 0.01 to 5% by weight of an aminocarboxylic acid.

20. The dispersion of claim 1, further comprising 0.3-20% by weight of an oxidizing agent.
